(19) United States
(12) Patent Application Publication
(10) Pub. No.: US 2016/0370589 A1
(43) Pub. Date: Dec. 22, 2016

(54) IMAGE DISPLAY APPARATUS

(71) Applicant: Coretronic Corporation, Hsin-Chu (TW)

(72) Inventors: Hsiang-Hua Wang, Hsin-Chu (TW); Chi-Tang Hsieh, Hsin-Chu (TW); Chung-Ting Wei, Hsin-Chu (TW)

(21) Appl. No.: 15/083,309

(22) Filed: Mar. 29, 2016

(30) Foreign Application Priority Data
Jun. 18, 2015 (TW) 104119757

(51) Int. Cl. G02B 27/01; F21V 8/00; G02B 27/28; G02C 7/02

(52) U.S. Cl. CPC G02B 27/0176; G02C 7/02; G02B 27/0172; G02B 6/0088; G02B 6/0056; G02B 6/0026; G02B 27/283; G02B 6/0055; G02B 2027/0174; G02B 2027/015; G02B 2027/0152

(57) ABSTRACT

An image display apparatus adapted to dispose in front of at least one eye of a user and including a frame, a projecting optical system, at least one waveguide and at least one lens is provided. The projecting optical system is configured to provide an image beam and disposed on the frame. The waveguide and the lens are disposed on the transmission path of the image beam. The waveguide has a side surface and the side surface has a first curvature. The waveguide is disposed on a surface of the lens. The surface has a second curvature and the first curvature is the same as the second curvature to bond the side surface and the surface with each other. The image beam is transmitted to the eye through the lens to display a virtual image after being transmitted to the lens through the waveguide.

### CROSS-REFERENCE TO RELATED APPLICATION

This application claims the priority benefit of Taiwan application serial no. 104119757, filed on Jun. 18, 2015. The entirety of the above-mentioned patent application is hereby incorporated by reference herein and made a part of this specification.

### BACKGROUND OF THE INVENTION

Field of the Invention

The invention relates to an image display apparatus, more particularly to an image display apparatus having waveguide.

Description of Related Art

Along with technology improvement and people's desire for high technology, virtual reality (VR) and augmented reality (AR) technologies have been well developed, wherein the head-mounted display (HMD) is the display used to realize these technologies. The developing history of the head-mounted display can be traced back to the US military in the 1970s, the head-mounted display utilizes a projecting optical system to project images or text messages on a display to the user's eye. In recent years, the head-mounted display has become a portable display device along with the increasing of the resolution of the micro-display and the decreasing of the size and power consumption of the micro-display. Besides military applications, the display technology of the head-mounted display has grown and occupied important positions in other fields, such as industrial production, simulation training, three-dimensional display, medical, sport, navigation and electronic game, etc.

Generally, the head-mounted display needs to be worn on the head so that the weight of the head-mounted display is necessarily considered in design. On the other hand, since the optical system of the head-mounted display is configured in the vicinity of the eye, if a strong impact happens, the optical structure will be fragmented to cause a safety problem. In order to solve these problems, the optical system of some head-mounted displays is configured at the position where the lens is placed in the glass, but this structural design will cause inconvenience for the user with myopia. Therefore, how to take account of safety and convenience of the head-mounted display has become one of the important topics related to the development of the technology field.

The information disclosed in this “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention was acknowledged by a person of ordinary skill in the art.

### SUMMARY OF THE INVENTION

The invention provides an image display apparatus which can take account of requirements about safety and convenience.

Other target and advantage of the invention provide a better understanding based on the technical characteristic that is disclosed.

In order to achieve at least one of the objects or other objects, an embodiment of the invention provides an image display apparatus. The image display apparatus is adapted to dispose in front of at least one eye of a user. The image display apparatus including a frame, a projecting optical system, at least one waveguide, and at least one lens is provided. The projecting optical system is configured to provide an image beam and disposed on the frame. The waveguide is disposed on a transmission path of the image beam, wherein the waveguide has a side surface, and the side surface has a first curvature. The lens is disposed on the transmission path of the image beam, wherein the waveguide is disposed on a surface of the at least one lens. The surface has a second curvature, the first curvature of the side surface is the same as the second curvature of the surface of the at least one lens, so that the side surface and the surface are bonded with each other. The image beam is transmitted to the eye of the user through the lens to display a virtual image after being transmitted to the lens through the at least one waveguide.

Based on the above, the embodiments in the invention can achieve at least one of the following advantage and effect. The structural strength of the image display apparatus of the embodiments in the invention is strengthened via bonding the side surface of the waveguide and the surface of the lens with each other, so as to prevent the risk of fragmentation when the projecting optical system is subject to impact. In addition, the structural strength of the image display apparatus is also strengthened via configuring the transparent adhesive and the transparent support member, and since the transparent adhesive or the transparent support member are configured to be adjacent to the periphery of the lens, the view of the user may be prevented from being affected.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an image display apparatus of one embodiment of the invention.

FIG. 2A to FIG. 2C are schematic views of light paths of different waveguides applied in FIG. 1.

FIG. 3 is a schematic view illustrating an image display apparatus of another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

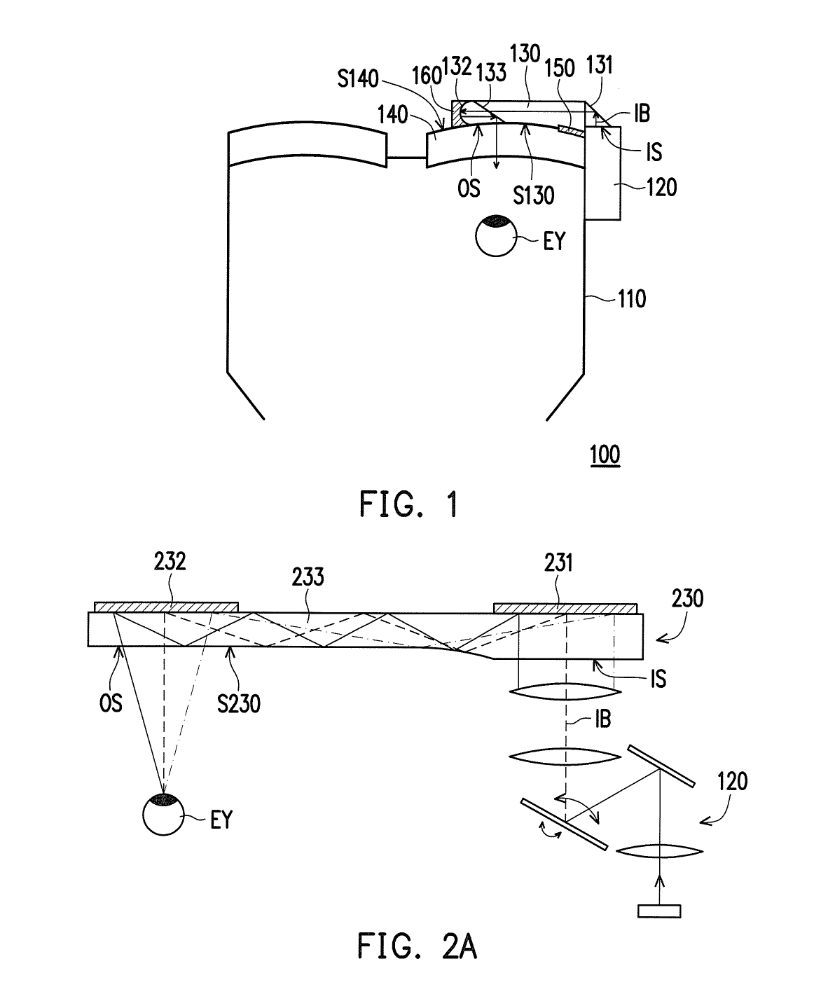

FIG. 1 is a schematic view illustrating of an image display apparatus of one embodiment of the invention. Referring to FIG. 1, in the embodiment, an image display apparatus 100 is adapted to dispose in front of at least one eye EY of a user. The image display apparatus 100 includes a frame 110, a projecting optical system 120, at least one waveguide 130 (one waveguide is depicted in FIG. 1), and at least one lens 140 (two lenses are depicted in FIG. 1). The projecting optical system 120 is configured to provide an image beam IB, and the projecting optical system 120 is disposed on the frame 110. For example, in the embodiment, the projecting optical system 120 may include a miniature Liquid Crystal Display panel (LCD panel), a Liquid Crystal on Silicon (LCOS) micro-display, or other types of micro-display, but the invention is not limited thereto. On the other hand, in the embodiment, the material of the waveguide 130 and the lens 140 is, for example, at least one of glass or plastic, but the invention is not limited thereto. The material of the waveguide 130 and the lens 140 can be other appropriate transparent materials. Moreover, in the embodiment, the lens 140 may be a prescription lens, namely, the lens 140 can be a lens with diopter, so as to facilitate the user with myopia or hyperopia to have a clear view in front of the eye and to have a clear observation of the image which is displayed by the image display apparatus 100 at the same time.

Specifically, in the embodiment as shown in FIG. 1, the waveguide 130 is disposed on a transmission path of the image beam IB, wherein the waveguide 130 has a side surface S130, and the side surface S130 has a first curvature. In addition, the waveguide 130 is disposed on a surface S140 of the lens 140. The surface S140 of the lens 140 has a second curvature, and the first curvature of the side surface S130 is substantially identical to the second curvature of the surface S140 of the lens 140, so as to bond the side surface S130 of the waveguide 130 and the surface S140 of the lens 140 with each other. Therefore, the structural strength of the image display apparatus 100 is strengthened, so as to reduce the risk of fragmentation when the projecting optical system 120 is subject to impact.

Specifically, in the embodiment, the waveguide 130 has a light incident surface IS and a light emitting surface OS, wherein the light incident surface IS is located near the projecting optical system 120, the light emitting surface OS is located near the lens 140, the projecting optical system 120 provides the image beam IB which enters the waveguide 130 via the light incident surface IS and transfers to the lens 140 via the light emitting surface OS. In other words, in the embodiment as shown in FIG. 1, the light emitting surface OS is a part of the side surface S130, and a curvature of the light emitting surface OS is identical to the first curvature, so that a virtual image may be displayed as the image beam IB is transmitted to the lens 140 via the light emitting surface OS.

More specifically, as shown in FIG. 1, the waveguide 130 of the embodiment further includes a first reflecting member 131, a second reflecting member 132 and a polarizing beam splitter (PBS) 133. The image beam IB is reflected by the first reflecting member 131 to transfer through the polarizing beam splitter 133 to the second reflecting member 132 after entering the waveguide 130 via the light incident surface IS of the waveguide 130. Then the image beam IB is reflected to the polarizing beam splitter 133 via the second reflecting member 132, finally, the image beam IB is transmitted to the lens 140 through the polarizing beam splitter 133 and the light emitting surface OS. In other words, the waveguide 130 in the embodiment is a reflective waveguide, but the invention is not limited thereto. In other embodiments, the waveguide 130 can also be at least one of a diffractive waveguide, a holographic waveguide, or a polarized waveguide.

On the other hand, in the embodiment as shown in FIG. 1, the lens 140 is disposed on the transmission path of the image beam IB, the image beam IB is transmitted to the eye of the user via the lens 140 to display the virtual image after being transmitted to the lens 140 via the waveguide 130.

The first reflecting member 131 of the waveguide 130 may be, for example, adhered to the light incident surface IS of the projecting optical system 120, so that the image beam IB from the projecting optical system 120 can enter the waveguide 130 directly via the first reflecting member 131. In addition, as shown in FIG. 1, the image display apparatus 100 of the embodiment is optionally configured with a transparent adhesive 150 or a transparent support member 160. An optical adhesive can be adopted to be material of the transparent adhesive 150, while a high light transmittance plastic or resin can be adopted to be material of the transparent support member 160, and transparent materials having refractive index closed to the refractive index of the lens 140 is preferably adopted, but the invention is not limited thereto.

To be more specific, the transparent adhesive 150 is disposed between the waveguide 130 and the lens 140. The transparent adhesive 150 is adjacent to the periphery of the lens 140 to adhere the waveguide 130 and the lens 140. In addition, the transparent support member 160 is disposed on the surface S140 of the lens 140 and near the waveguide 130, wherein the transparent support member 160 is adjacent to the periphery of the lens 140. The structural strength of the image display apparatus 100 is strengthened via configuring the transparent adhesive 150 and the transparent support member 160, so as to reduce the risk of fragmentation when the projecting optical system 120 is subject to impact. In addition, since the transparent adhesive 150 or the transparent support member 160 are configured to be adjacent to the periphery of the lens 140 (a position far from the eye EY at the lens 140), the view of the user may be prevented from being affected.

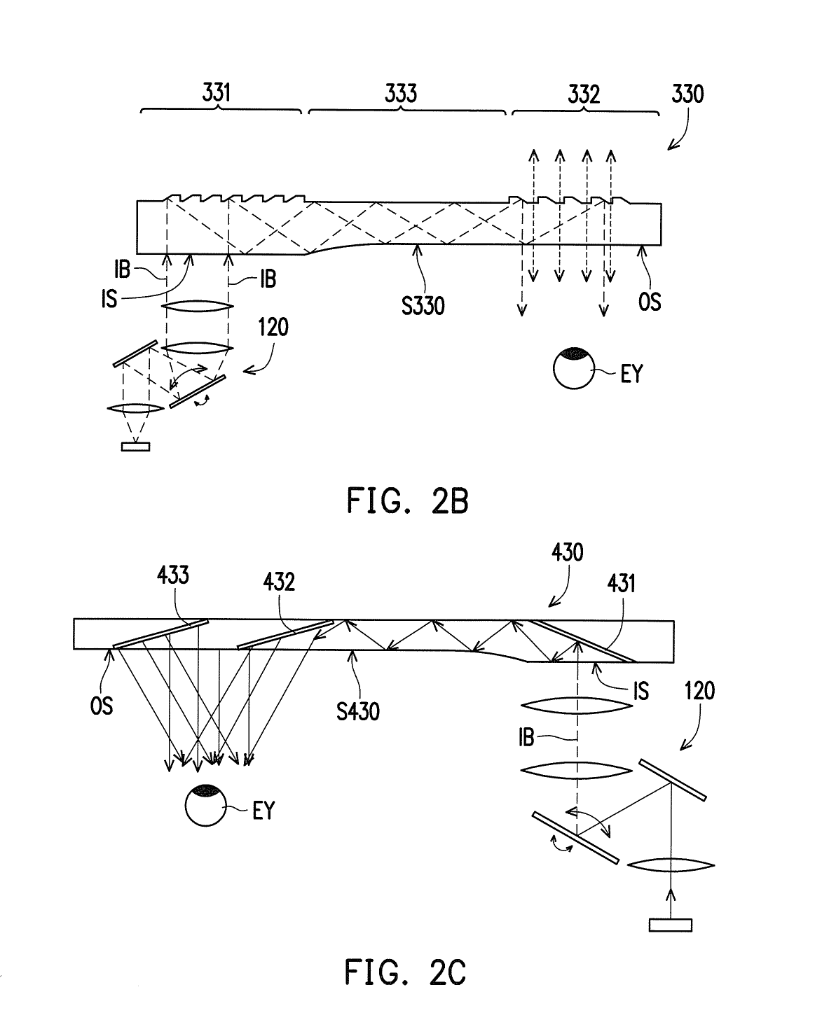

The waveguide 130 of the embodiment is the reflective waveguide as an example, but the invention is not limited thereto. In other embodiments, the waveguide 130 can be other different types of waveguide. Further, explanations of the variation of the waveguide 130 in FIG. 1 are illustrated as follow together with FIG. 2A to FIG. 2C.

FIG. 2A to FIG. 2C are schematic views of light paths of different waveguides applied in FIG. 1. Referring to FIG. 2A to FIG. 2C, in these embodiments, the waveguides 230, 330, 430 are holographic waveguide, diffractive waveguide, or polarized waveguide respectively.

Specifically, as shown in FIG. 2A, the waveguide 230 is a holographic waveguide which includes a first hologram 231, a second hologram 232 and a main body 233, wherein the curvature of the side surface S230 is the same as the curvature of the side surface S140 of the lens 140 (not shown in FIG. 2A), so that the side surface S230 is adhered to the side surface S140. The first hologram 231 and the second hologram 232 are, for example, reflection holograms, wherein the first hologram 231 can be an in-coupling hologram, the second hologram 232 can be an out-coupling hologram. The first hologram 231 is adapted to reflect the image beam IB and the image beam IB is transmitted to the second hologram 232 via total reflection in the main body 233 after the image beam IB enters the waveguide 230 via the light incident surface IS of the waveguide 230, and the second hologram 232 is adapted to reflect the image beam IB to transfer to the light emitting surface OS of the waveguide 230. Finally, the image beam IB is transmitted to the eye EY of the user through the lens 140 to display a virtual image. The technologies and principles related to the holographic waveguide should be known to people having ordinary skill in the art, and will not be repeated herein.

As shown in FIG. 2B, the waveguide 330 is a diffractive waveguide which includes an in-coupling region 331, an out-coupling region 332 and a middle region 333, wherein the curvature of the side surface S330 is the same as the curvature of the side surface S140 of the lens 140 (not shown in FIG. 2B), so that the side surface S330 is able to adhered to the side surface S140. The image beam IB is transmitted to the middle region 333 via the in-coupling region 331 after entering the waveguide 330 via the in-coupling region IS of the waveguide 330, then the image beam IB is transmitted via total reflection in the middle region 333 to the out-coupling region 332, and finally the image beam IB is transmitted to the light emitting surface OS of the waveguide 330 via the out-coupling region 332. Afterwards, the image beam IB is transmitted to the eye EY of the user through the lens 140 to display a virtual image. The technologies and principles related to the diffractive waveguide should be known to people having ordinary skill in the art, and will not be repeated herein.

As shown in FIG. 2C, the waveguide 430 is a polarized waveguide which includes a reflecting member 431, a first polarizing beam splitter 432 and a second polarizing beam splitter 433, wherein the curvature of the side surface S430 is the same as the curvature of the side surface S140 of the lens 140 (not shown in FIG. 2C), so that the side surface 5430 is adhered to the side surface S140. The image beam IB is reflected via the reflecting member 431 to transfer to the first polarizing beam splitter 432 and the second polarizing beam splitter 433 after entering the waveguide 430 via the light incident surface IS of the waveguide 430, and the image beam IB is transmitted through the light emitting surface OS to the eye EY of the user via the first polarizing beam splitter 432 and the second polarizing beam splitter 433 respectively. The technologies and principles related to the polarized waveguide should be known to people having ordinary skill in the art, and will not be repeated herein.

In the above-mentioned embodiments, the amount of the waveguide 130, 230, 330 and 430 is one as an example, but the invention is not limited thereto. In other embodiments, more than two of the waveguides may be configured, and the amount of the waveguides is corresponding to the amount of the lenses 140.

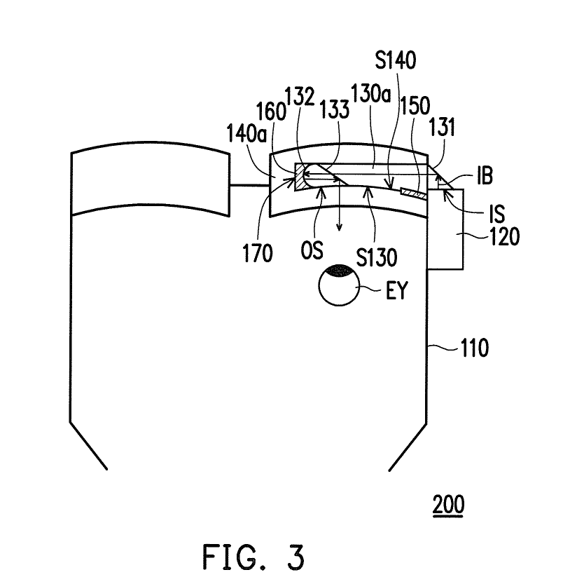

FIG. 3 is a schematic view illustrating of an image display apparatus of another embodiment of the invention. Referring to FIG. 3, the image display apparatus 200 in the embodiment is similar to the image display apparatus 100 in FIG. 1, the similar elements are represented by the same number. The difference between the image display apparatus 200 and the image display apparatus 100 is that at least one waveguide 130a of the image display apparatus 200 is embedded into at least one lens 140a. For example, the waveguide 130a in the embodiment is embedded into the notch 170 of the lens 140a, but the invention is not limited thereto. The waveguide 130a can be is embedded into a through hole of the lens 140a, and the lens 140a can also be constructed by a plurality of sub-lenses which are superimposed with each other. In addition, the transparent adhesive 150 is disposed between the waveguide 130a and the lens 140a, and the transparent adhesive 150 is adjacent to the periphery of the lens 140a, so as to adhere the waveguide 130a and the lens 140a. The transparent support member 160 is located at the bottom of the notch 170 and adjacent to the periphery of the lens 140a, so as to position the waveguide 130a, wherein the side surface S130 of the waveguide 130a is bonded to the surface S140 of the notch 170. Since the waveguide 130a in the embodiment is embedded into the lens 140a, besides that the structural strength of the image display apparatus 200 is appropriately strengthened, the space occupied by the image display apparatus 200 is also reduced.

In summary, the structural strength of the image display apparatus of the embodiments in the invention is strengthened via bonding the side surface of the waveguide and the surface of the lens with each other, so as to prevent the risk of fragmentation when the projecting optical system is subject to impact. In addition, the structural strength of the image display apparatus may also be strengthened by configuring the transparent adhesive and the transparent support member. Since the transparent adhesive or the transparent support member may be configured to be adjacent to the periphery of the lens, the view of the user may be prevented from being affected.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An image display apparatus, adapted to dispose in front of at least one eye of a user, comprising:
a frame;
a projecting optical system, configured to provide an image beam and disposed on the frame;
at least one waveguide, disposed on a transmission path of the image beam, wherein the at least one waveguide has a side surface, and the side surface has a first curvature; and
at least one lens, disposed on the transmission path of the image beam, wherein the at least one waveguide is disposed on a surface of the at least one lens, the surface has a second curvature, the first curvature of the side surface is substantially identical to the second curvature of the surface of the at least one lens, so that the side surface and the surface are bonded with each other, and the image beam is transmitted to the eye of the user through the lens to display a virtual image after being transmitted to the lens through the at least one waveguide.

2. The image display apparatus as recited in claim 1, wherein the at least one waveguide is embedded into the at least one lens.

3. The image display apparatus as recited in claim 1, wherein material of the waveguide is at least one of glass or plastic.

4. The image display apparatus as recited in claim 1, wherein an amount of the at least one waveguide is more than two.

5. The image display apparatus as recited in claim 1, wherein the waveguide is at least one of a diffractive waveguide, a holographic waveguide, a polarized waveguide, or a reflective waveguide.

6. The image display apparatus as recited in claim 1, wherein an amount of the at least one waveguide is corresponding to an amount of the at least one lens.

7. The image display apparatus as recited in claim 1, wherein the at least one lens is a prescription lens.

8. The image display apparatus as recited in claim 1, wherein material of the lens is at least one of glass or plastic.

9. The image display apparatus as recited in claim 1, further comprising:
a transparent adhesive, disposed between the at least one waveguide and the at least one lens, wherein the transparent adhesive is adjacent to a periphery of the at least one lens.

10. The image display apparatus as recited in claim 1, further comprising:
a transparent support member, disposed on the at least one lens and leaned against the at least one waveguide, wherein the transparent support member is adjacent to a periphery of the at least one lens.

11. The image display apparatus as recited in claim 1, wherein the waveguide further comprises:
a first reflecting member;
a second reflecting member; and
a polarizing beam splitter, wherein the image beam is reflected via the first reflecting member to transfer through the polarizing beam splitter to the second reflecting member after entering the waveguide, the image beam is reflected to the polarizing beam splitter via the second reflecting member, and then the image beam is transmitted to the lens via the polarizing beam splitter.

12. The image display apparatus as recited in claim 1, wherein the waveguide further comprises:
a first hologram;
a second hologram; and
a main body, wherein the image beam is reflected via the first hologram to transfer through the main body to the second hologram after entering the waveguide, and then the image beam is transmitted to the lens via the second hologram.

13. The image display apparatus as recited in claim 1, wherein the waveguide further comprises:
an in-coupling region;
an out-coupling region; and
a middle region, wherein the image beam is transmitted to the middle region via the in-coupling region after entering the waveguide, and the image beam is transmitted in the middle region to the out-coupling region, and then the image beam is transmitted to the lens via the out-coupling region.

14. The image display apparatus as recited in claim 1, wherein the waveguide further comprises:
a reflecting member;
a first polarizing beam splitter; and
a second polarizing beam splitter, wherein the image beam is reflected via the reflecting member to transfer to the first polarizing beam splitter and the second polarizing beam splitter after entering the waveguide, and the image beam is transmitted to the eye of the user via the first polarizing beam splitter and the second polarizing beam splitter respectively.
